(19) United States
(12) Patent Application Publication
(10) Pub. No.: US 2017/0120932 A1
(43) Pub. Date: May 4, 2017

(54) GESTURE-BASED VEHICLE-USER INTERACTION

(71) Applicant: GM Global Technology Operations LLC, Detroit, MI (US)

(72) Inventors: Joseph F. Szczerba, Grand Blanc, MI (US); Tricia E. Neiiendam, Oakland Township, MI (US); Peng Lu, Troy, MI (US); Xiaosong Huang, Novi, MI (US)

(21) Appl. No.: 15/342,451

(22) Filed: Nov. 3, 2016

Related U.S. Application Data
(60) Provisional application No. 62/250,180, filed on Nov. 3, 2015.

(51) Int. Cl. B60W 50/10; G06F 3/01

(52) U.S. Cl. CPC B60W 50/10; G06F 3/017

(57) ABSTRACT

A system, for use in implementing a vehicle function based on user gesture, including a hardware-based processing unit and a hardware-based storage device. The storage device includes a user-gesture determination module that, when executed by the hardware-based processing unit, determines a user gesture, made by a user proximate a vehicle, wherein the user gesture is not an under-vehicle user kick. The storage device also includes a vehicle-function identification module that, when executed by the hardware-based processing unit, determines a vehicle function pre-associated with the user gesture determined. The storage device further includes a vehicle-function activation module that, when executed by the hardware-based processing unit, initiates performance of the vehicle function identified. In various embodiments the technology includes the storage device, and processes including any of the operations described.

### TECHNICAL FIELD

The present disclosure relates generally to systems and methods facilitating gesture-based communications between an apparatus and a gesturing user and, more particularly, to systems and methods facilitating gesture-based communications between a gesturing user and a vehicle.

### BACKGROUND

Modern vehicles have numerous electronic features promoting convenience and safety. A basic example is the vehicle lock/unlock function actuatable by user button press at a portable key fob or vehicle-mounted keypad. Users save time by not having to enter a traditional key into the vehicle.

Fob systems can be safer for users than traditional keys as users do not need to take keys out of their pocket, or at least not insert into the vehicle. A keypad system can be safer as users do not need to fiddle for their key or fob at all, such as in the evening in a grocery store parking lot.

Most key fobs also have a button allowing a user to generate a vehicle alert. In most cases, a vehicle horn is cycle actuated until the alert is turned off or timed out. Many fobs also include a button allowing the user to pop open the deck lid or tailgate.

Another recent vehicle feature is the kick-activated tailgate. One or more under-vehicle sensors trigger opening of the tailgate when sensing a user foot kicked beneath the rear bumper. The feature requires that the vehicle first unlock the tailgate, such as in response to determining that the key fob is proximate. The feature is convenient when a user has their hands full with items to place in the cargo area, and safer as the user does not need to find or actuate a key fob to open the tailgate.

### SUMMARY

The systems and methods of the present disclosure allow users to activate vehicle functions by bodily gesture, such as hand or arm gestures. The term gesture is not used in a limited sense and can include any movement.

The systems and methods thus allow activation of such functions in a hands-free manner, without need to type in a code, use a finger print, or need of a traditional key fob, for instance. In this way, the traditional notion of the user-vehicle, or human-machine, interface (UVI, or HMI) are expanded, for improved user convenience, safety, and overall experience.

In various embodiments, a wearable device, worn by the user, communicates with the vehicle to initiate vehicle functions. The wearable device is configured, in some embodiments, to send various signals to the vehicle based on user motions involving the wearable device.

A first motion of a user arm bearing a computerized wearable device, such as a bracelet or smart watch, can cause the bracelet or watch to, in response to the first motion, send a first corresponding signal to the vehicle in order to, for example, unlock-doors signal. A second motion of the user arm can cause the bracelet or watch to, in response to the second motion, send a second corresponding signal to the vehicle in order to, for example, initiate an emergency call, such as by cellular or satellite-based communication.

Example vehicle functions include initiating an emergency call or locking or unlock one or more doors, as mentioned, sending a text, multi-media, or e-mail message, turning on (illuminating)/off or blinking vehicle lights (e.g., under-vehicle lights, interior lights, standard head and tail lamps, and/or other), actuating a vehicle horn, determining a vehicle location, transmitting vehicle location (such as by the emergency call, text, or email), initiating taking a video, such as of an environment including the user (such as in a situation in which the user feels unsafe), and transmitting the video (such as by the emergency call, text, or email).

Communications can be sent to a remote system, such as to a remote call or control center, like the OnStar® system. Such centers have facilities for interacting with vehicle agent team members and their user team members via long-range communications, such as satellite or cellular communications. OnStar is a registered trademark of the OnStar Corporation, a subsidiary of the General Motors Company.

The vehicle is configured in some embodiments to sense and respond to wearable-device movement while the device is being moved outside of the vehicle, as well as to sense and respond to wearable-device movement while the device is being moved inside of the vehicle as well.

The vehicle is configured in some embodiments to sense and respond to user hand or arm gestures, even in some cases in which a wearable is not involved. The vehicle can be configured to, in response to a first motion of a user hand or arm—even sans bracelet, watch, etc.—cause the vehicle to perform a first corresponding function (e.g., lock the doors); to, in response to a second motion of the user hand or arm, perform a second corresponding function (e.g., send a text message); etc.

In contemplated embodiments, the vehicle is configured to sense and respond similarly to gestures performed with other user body parts, in addition to or instead of the hands and arms. The vehicle can be configured to sense and respond to head movements, for instance, while the user is within and/or configured to sense and respond to head movements when the user is outside of the vehicle.

Other aspects of the present invention will be in part apparent and in part pointed out hereinafter.

### DESCRIPTION OF THE DRAWINGS

FIG. 1 illustrates schematically an example computer architecture, according to an embodiment of the present disclosure.

FIG. 2 shows example memory components of the computer architecture of FIG. 1.

FIG. 3 shows an example wearable device, worn on a user, and sample user motions, according to embodiments of the present technology.

FIG. 4 shows an example method, according to embodiments of the present technology.

FIG. 5 shows example system inputs and outputs, according to embodiments of the present technology.

The figures are not necessarily to scale and some features may be exaggerated or minimized, such as to show details of particular components.

### DETAILED DESCRIPTION

As required, detailed embodiments of the present disclosure are disclosed herein. The disclosed embodiments are merely examples that may be embodied in various and alternative forms, and combinations thereof. As used herein, for example, “exemplary,” and similar terms, refer expansively to embodiments that serve as an illustration, specimen, model or pattern.

In some instances, well-known components, systems, materials or methods have not been described in detail in order to avoid obscuring the present disclosure. Specific structural and functional details disclosed herein are therefore not to be interpreted as limiting, but merely as a basis for the claims and as a representative basis for teaching one skilled in the art to employ the present disclosure.

### I. Introduction

The systems of the present disclosure in various embodiments include specially configured vehicle apparatus and, in some implementations, specially configured wearable user devices.

Vehicle apparatus include any of select sensors and communication receivers for receiving user inputs, specially programmed computing components for determining vehicle functions corresponding to user inputs, and output components for activating or actuating the vehicle functions identified.

Wearable devices are configured in various embodiments to generate and send signals, for receipt by the vehicle, based on motion of the user. The vehicle apparatus is configured to respond to wearable-device signals, by activating or actuating a corresponding function, such as flashing vehicle lights or initiating a phone call.

While the present technology is described primarily herein in connection with automobiles, the technology is not limited by the focus. The concepts can be extended to a wide variety of applications, such as aircraft, marine craft, manufacturing machinery or equipment, home appliances, the like, and other.

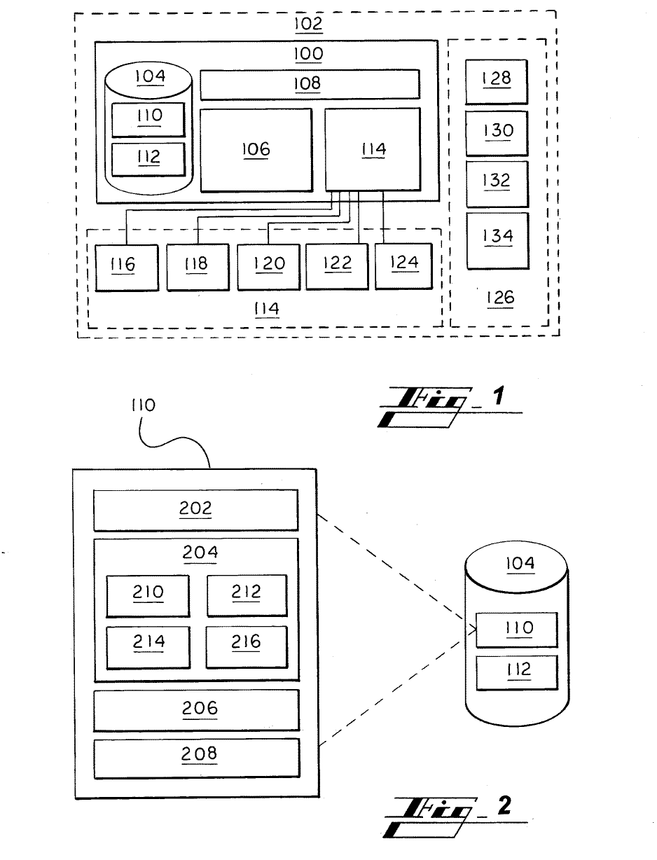

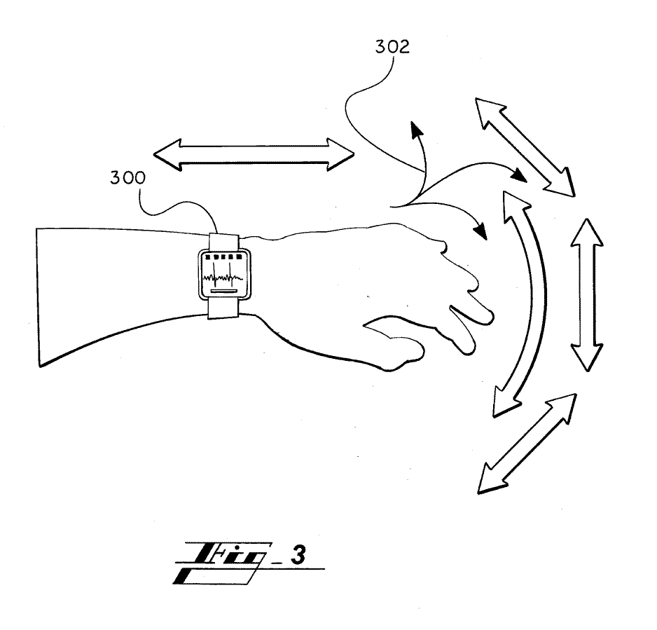

Example systems are now described, and shown schematically, in connection with FIGS. 1 and 2.

### II. On-Board Computing Architecture—FIG. 1

Turning now to the figures and more particularly the first figure, FIG. 1 illustrates a computer-based system 100, such as an on-board computer (OBC) of a vehicle 102.

In a contemplated embodiment, some or all of the computing system 100 is positioned at a remote call or control center, like the mentioned OnStar® system.

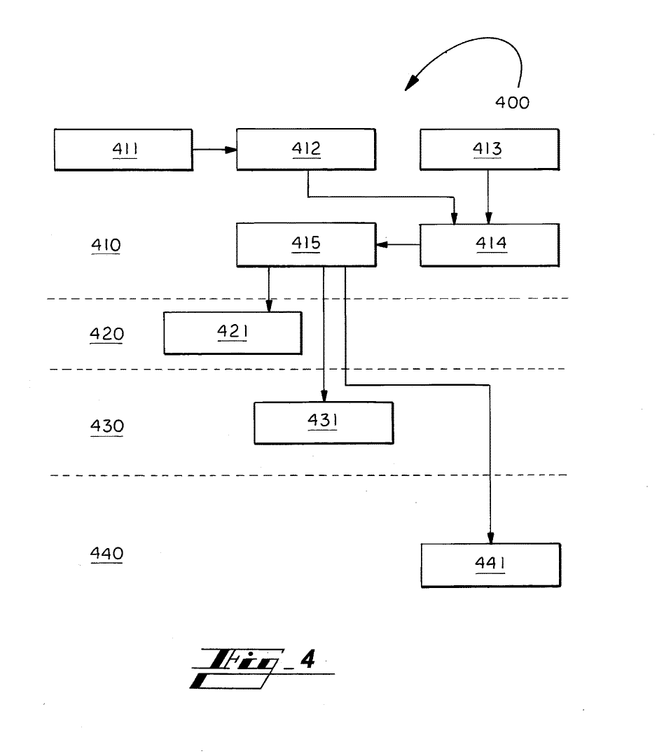

The computer-based system 100 of FIG. 1 can also be a model for other electronic systems of the present technology, such as of a wearable device—e.g., smart bracelet, ring, cufflink(s), belt attachment, shoe or boot (footwear) attachment, legwear, arm wear, clothing, headphones, headgear, hat or other headwear, watch, eyeglasses, sunglasses, earrings, etc.—as described more below, including in connection with FIG. 3.

In the present section, the computer-based system 100 is described primarily as a vehicle on-board computer (OBC). The OBC 100 can be, or be a part of, a primary computing unit of the vehicle 102, such as an electronic control unit (ECU) of the vehicle 102.

The system and components thereof can be hardware-based. The OBC 100 includes a computer-readable storage medium, or data storage device 104 and also includes a processing hardware unit 106 connected or connectable to the computer-readable storage device 104 by way of a communication link 108, such as a computer bus.

The processing hardware unit 106 can include or be multiple processors, which could include distributed processors or parallel processors in a single machine or multiple machines. The processing hardware unit can be used in supporting a virtual processing environment. The processing hardware unit could include a state machine, application specific integrated circuit (ASIC), programmable gate array (PGA) including a Field PGA, or state machine. References herein to the processing hardware unit executing code or instructions to perform operations, acts, tasks, functions, steps, or the like, could include the processing hardware unit performing the operations directly and/or facilitating, directing, or cooperating with another device or component to perform the operations.

In various embodiments, the data storage device is any of a volatile medium, a non-volatile medium, a removable medium, and a non-removable medium. The term computer-readable media and variants thereof, as used in the specification and claims, refer to tangible storage media. The media can be a device, and can be non-transitory.

In some embodiments, the storage media includes volatile and/or non-volatile, removable, and/or non-removable media, such as, for example, random access memory (RAM), read-only memory (ROM), electrically erasable programmable read-only memory (EEPROM), solid state memory or other memory technology, CD ROM, DVD, BLU-RAY, or other optical disk storage, magnetic tape, magnetic disk storage or other magnetic storage devices.

The data storage device 104 includes one or more storage modules storing computer-readable instructions executable by the processor 106 to perform the functions of the OBC 100 described herein.

For instance, the data storage device 104 includes team-based vehicle-machine framework modules 110. The data storage device 104 in some embodiments also includes ancillary or supporting components 112, such as additional software and/or data supporting performance of the methods of the present disclosure.

The vehicle 102 also includes a communication sub-system 114 for communicating with external devices. If a user initiates an emergency call or text message by way of gesture—whether by way moving a worn device, or simply by body movement, the vehicle 102 can use the communication sub-system 114 to make the call or send the text message.

The communication sub-system 114 can include a wire-based input/output (i/o) 116, at least one long-range wireless transceiver 118, and at least one short-range wireless transceiver 120. Other ports 122, 124 are shown schematically to emphasize that the system can be configured to accommodate other types of wired or wireless communications.

The vehicle 102 also includes a sensor sub-system 126 comprising sensors providing information to the OBC 100, such as information indicating presence and movement of a proximate vehicle user. The vehicle 102 can be configured so that the OBC 100 communicates with, or at least receives signals from sensors of the sensor sub-system 126, via wired or short-range wireless communication links 116, 120.

In some embodiments, the sensor sub-system 126 includes at least one camera 128 and at least one range sensor 130. Range sensors, used typically in support of driving functions, can include a short-range radar (SRR), an ultrasonic sensor, a long-range RADAR, such as those used in autonomous or adaptive-cruise-control (ACC) systems, or a Light Detection And Ranging (LiDAR) sensor.

The camera 128 shown schematically can represent one or multiple cameras positioned in any appropriate or suitable location of the vehicle 102, such as at vehicle side mirrors, adjacent or at door handles, at a rear decklid, facing out from vehicle head and/or tail lamps, etc.

Each camera 128 is configured to sense presence of a user and, in some embodiments, user motion. Each can be movable, such automatically moved by actuator controlled by the computer system 100 to track a user moving near the vehicle. Cameras can be used in conjunction with other sensors, such as laser-motion detecting sensors, to recognize user gestures.

Sensors sensing user motion, including gestures, may be oriented in any of a variety of directions without departing from the scope of the present disclosure. For example, cameras 128 and radar 130 may be oriented at each, or a select, position of, for example: (i) facing forward from a front center point of the vehicle 102, (ii) facing rearward from a rear center point of the vehicle 102, (iii) facing laterally of the vehicle from a side position of the vehicle 102, and (iv) facing diagonally—e.g., between fore and directly laterally—of the vehicle 102.

The long-range transceiver 118 is in some embodiments configured to facilitate communications between the OBC 100 and a satellite and/or a cellular telecommunications network. The short-range transceiver 120 is configured to facilitate short-range communications, such as communications with other vehicles, in vehicle-to-vehicle (V2V) communications, and communications with transportation system infrastructure (V2I).

To communicate V2V, V2I, with road-side or other infrastructure (V2I), or with other extra-vehicle devices (V2X), such as local communication routers, etc., the short-range communication transceiver 120 may be configured to communicate by way of one or more short-range communication protocols. Example protocols include Dedicated Short-Range Communications (DSRC), WI-FI®, BLUETOOTH®, infrared, infrared data association (IRDA), near field communications (NFC), the like, or improvements thereof (WI-FI is a registered trademark of WI-FI Alliance, of Austin, Tex.; BLUETOOTH is a registered trademark of Bluetooth SIG, Inc., of Bellevue, Wash.).

The extra-vehicle, or external, devices to which the OBC 100 can communicate in execution of the functions of the present technology, can include a remote control center. The control center can be the control center of the OnStar® system mentioned.

Other sensor sub-systems 126 include an inertial-momentum unit (IMU) 132, used mostly in support of autonomous driving functions, such as one having one or more accelerometers, and/or other such dynamic vehicle sensors 134, such as a wheel sensor or a sensor associated with a steering system (e.g., steering wheel) of the vehicle 102.

### III. Data Storage and Example Wearable Devices—FIGS. 2 and 3

FIG. 2 shows in more detail the data storage device 104 of FIG. 1. The components of the data storage device 104 are now described further with reference to the figure.

III.A. Memory Components

As provided, the data storage device 104 includes one or more modules 110. And the memory may also include ancillary components 112, such as additional software and/or data supporting performance of the methods of the present disclosure.

The ancillary components 112 can include, for example, one or more user profiles. The profiles can including settings, default and/or custom set, for one or more users (e.g., drivers) of the vehicle. These and other data components are described elsewhere, herein, including below in connection with the methods 400, of operation. The technology can be personalized, or customized in these ways.

The modules 110 can include at least three (3) modules 202, 204, 206, described further in the next section. In one embodiment, the modules 110 include one or more additional modules. Some instructions can be part of more than one module, and functions described herein can be performed by processor execution of the corresponding more than one module.

Functions described herein, but not in connection expressly with one of the three modules 202, 204, 206 can be a part of one of the three modules and/or a part of an additional supporting module or modules 208. The supporting module(s) 208 can include, for example, a user-identification module, a passenger-identification module, a learning module (to, e.g., learn user gesture style, or natural movement or gesture types of the user, for improving efficiency and effectiveness or user-system interaction), and/or a recommendation, suggestion or teaching module (e.g., to provide advice to a user on how to gesture for triggering select vehicle functions, for improving efficiency and effectiveness or user-system interaction).

Each of the modules can be referred to by any of a variety of names, such as by a term or phrase indicative of its function. The modules 202, 204, 206 of the present system 100 can be referred to as:
a user-gesture determination module 202;
a vehicle-function identification module 204;
a vehicle-function activation module 206;
   the like, or other, for example.

FIG. 2 shows an additional module with reference numeral 208 to show expressly that the system 100 can include one or more additional modules.

Any of the modules can include sub-modules, such as shown by reference numerals 210, 212, 214, 216 in connection with the second illustrated module 204. Sub-modules perform specific operations or routines of module functions.

III.A.i. User-Gesture Determination Module 202

The processing hardware unit 106, executing the user-gesture determination module 202, determines which gesture a user has made based on user input data. The user input data can include one or multiple data components. The user input data is received to the processing hardware unit 106, executing the module 202, from one or more of a variety of data sources.

Example data sources include one or more sensors of a wearable device, worn by the user, and one or more other sensors, such as of the vehicle 102, configured and arranged to sense motion of one or more user body parts, such as a user arm, wrist, head, etc.

The wearable device can include a smart bracelet, ring, cufflink(s), belt attachment, shoe or boot (footwear) attachment, legwear, arm wear, clothing, headphones, headgear, hat or other headwear, eyeglasses, rings, sunglasses, or watch, as just a few examples.

An example wearable device in the form of a smart bracelet is referenced by numeral 300 in FIG. 3. As referenced, the device 300 can be a computerized or electronic device having any components analogous to those shown in FIGS. 1 and 2—e.g., memory unit comprising executable instructions and a processing device for executing the instructions. FIGS. 1 and 2 is thus considered to, in addition to showing vehicle features, also, from another perspective show wearable-device features. In the interest of brevity, a separate figure showing another computing unit, like that of FIGS. 1 and 2, is not shown.

In various embodiments, the wearable device 300 includes at least one transmitter or transceiver components for at least sending signals or messages to the vehicle, such as signals or messages corresponding to user gestures. The transmitter/transceiver can have any of the qualities described above for the communication components of FIG. 1, or other characteristics. The transmitter/transceiver can be configured, for instance, to communicate according to any of a wide variety of protocols, including BLUETOOTH®, infrared, infrared data association (IRDA), near field communications (NFC), the like, or improvements thereof.

Example movements 302 include rotations in any direction, linear movements, and combinations of rotation and linear movement. Rotations can include twists, such as a twist or flick of the hand, wrist, or one or more fingers.

The rotations can also include movements causing the device 300 to travel along larger arcs, such as generally about a user elbow, as would occur if the user was making a waving motion. Linear motions can include the user moving their hand, and so wrist, straight down, such as an exaggerated motion of pushing down an imaginary conventional door lock rod.

Other contemplate motions include an arm motion whereby the user simulate pushing, tossing, or throwing an imaginary something (e.g., a text message) toward the vehicle, corresponding to a vehicle function (e.g., receiving the text message and processing—e.g., sending the message received), or pulling something from the vehicle.

While a wrist-mounted wearable device 300 is shown, the device 300 need not be configured to be worn only on the wrist. The device can include a ring, for instance, or eyeglasses, whereby finger or head gestures are relevant.

And as referenced, the system(s) is in some embodiments configured to record—such as by one or more vehicle sensors sensing—user gestures, whether the user is wearing a device 300.

As provided, the data source includes one or more sensors configured to sense motion of a user body part such as a wrist, head, arm, or hand. A user arm, wrist, and hand are shown in FIG. 3.

The sensors can include but are not limited to including those described above in connection with the sensor sub-system 126 of the system 100 of FIG. 1, such as at least one camera 128.

In a contemplated embodiment, the sensors can include a sensor of a wearable device 300. For instance, the user can wear a device—on a left wrist, around the neck (e.g., pendant, necklace), earing, ring, cufflink(s), belt attachment, shoe or boot (footwear) attachment, legwear, arm wear, clothing, headphones, headgear, hat or other headwear, rings, eyeglasses, sunglasses, etc.—configured to sense and report on (send a signal to the vehicle) motion of the right arm or hand. In a contemplated embodiment, the device 300 is not technically worn by the user, but held by the user, such as a user mobile phone. In a contemplate embodiment, the wearable, or other user device, is configured with at least one sensor, such as a RADAR based motion detector, to detect user movements, such as the watch 300 detecting finger movements, such as while the wrist and lower arm are not moving.

The device 300 can include any appropriate components for sensing user gestures or movement, such as camera components, an inertial-momentum unit (IMU)—such as that indicated by 132 for the interpretation by which the system 100 of FIG. 1 shows the device 300—such as one having one or more accelerometers.

In various embodiments, the vehicle 102 and/or the mobile device 300 is configured to determine whether the user is present or proximate the vehicle—such as by determining that the wearable device is proximate the vehicle 102. The vehicle may identify or authenticate the user presence for this purpose in any of a variety of ways, along with or in addition to detecting proximity of a user mobile device, such as by voice authentication, facial authentication, retina scan, etc. In various embodiments, the mobile device 300 and/or the vehicle only sense and/or act on user gestures after the presence or proximity determination is made at the mobile device and/or vehicle.

III.A.ii. Vehicle-Function Identification Module 204

The processing hardware unit 106, executing the vehicle-function identification module 204, determines a vehicle function corresponding to the gesture identified by the processing hardware unit 106 executing the user-gesture determination module 202.

As provided, any of the modules 202, 204, 206, 208 can include sub-modules, and any module and sub-module can be referred to by any of a variety of names, such as by a term or phrase indicative of its function. As an example, the vehicle-function identification module 204 can include sub-modules 210, 212, 214, 216.

The first sub-module 210 can be referred to as a look-up module, such as a data structure comprising a table correlating each of multiple pre-set user gestures (e.g., a hand wave) to respective vehicle functions (e.g., blink vehicle lights).

In various embodiments, the user gesture is relatively stealth so that it is generally undetectable, or not known as a vehicle trigger, by a casual observer. The gesture can include, for instance, the user waving their hand to a stranger while asking them to back away, the waving serving multiple purposes at the same time—warning the stranger to back away and triggering one or more vehicle functions, such as the vehicle starting to take a video, making an emergency call or video communication. As a more stealth example, the gesture can include a slight, quick wrist twist, or slight, quick wrist or hand pump in any predetermined direction or serially to more than one predetermined direction.

The second sub-module 212 can be referred to as a user-profile module.

The user-profile module 212 can include user preferences set by the user, such as preferred gestures and associated vehicle functions, wherein the preferred gestures differ from standard, or default, gestures associated originally with the vehicle functions.

In various embodiments, the user can pre-set one or more gestures, and associate each with a vehicle function. The settings can be stored in the user-profile.

In some implementations, the operations of the first module 202 use the user-profile module 212. The user-profile module can be a part of the first module 202 instead or along with being in the second module 204.

The third sub-module 214 can be referred to as a vehicle-function initiation module. The VFI module 214 can include instructions causing the processing hardware device 106 to, based on the vehicle function identified using the look-up module 210, initiate vehicle performance of the relevant function. The initiation can include, for instance, the processing hardware unit 106, executing instructions of the VFI module 214 generating and transmitting a signal or message configured to cause the vehicle to perform the function. The signal or message can be transmitted to the primary electronic control unit (ECU) of the vehicle 102, for instance, or a different part of the OBC 100, whether the OBC is a part of the ECU.

The fourth sub-module 216 is shown to indicate that the module 204 can include one or more additional sub-modules.

III.A.iii. Vehicle-Function Activation Module 206

The processing hardware unit 106 executing the vehicle-function activation module 206 performs the function(s) identified by the unit 106 executing the prior modules 202, 204. Example functions including initiate a 911 call, locking or unlocking doors, etc.

In some implementations, in which the OBC 100 is not a part of a vehicle ECU, the third module 206 can be a part of the ECU.

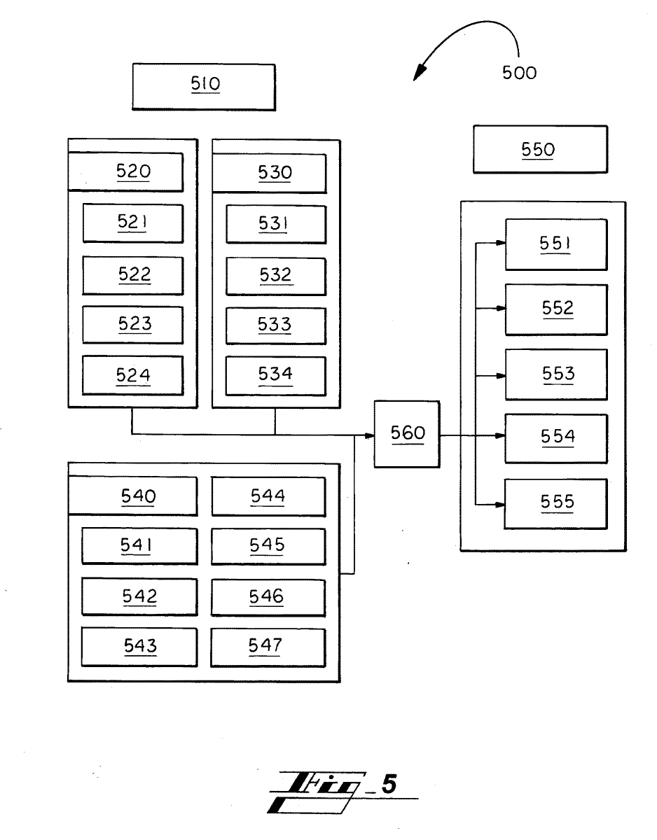

### IV. Example Methods of Operation—FIG. 4

FIG. 4 shows exemplary methods 400 according to embodiments of the present technology. More than one method is considered shown because various subsets of the operations shown can be implemented separately, in any combination, without departing from the scope of the present disclosure.

It should be understood that the steps, operations, or functions of the methods 400 are not necessarily presented in any particular order and that performance of some or all the steps in an alternative order is possible and is contemplated. The methods can also be combined or overlap, such as one or more steps of one of the methods being performed in the other method.

The steps have been presented in the demonstrated order for ease of description and illustration. Steps can be added, omitted and/or performed simultaneously without departing from the scope of the appended claims. It should also be understood that the illustrated methods 400 can be ended at any time.

In certain embodiments, some or all steps of the process(es) 400 and/or substantially equivalent steps are performed by a processor, e.g., computer processor, executing computer-executable instructions stored or included on a computer-readable medium, such as the data storage device 104 of the system 100 described above.

The flow of the process 400 is divided by way of example into four sections: a user personalization and input section 410, a comfort/convenience vehicle function section 420, a local alarm vehicle function section 430, and a remote communication or alert section 440.

At block 411, a user has or puts on a wearable or other mobile device, such as a smart phone. The mobile device is configured to sense user movement, such as of a user arm, head, wrist, fingers, etc., as described. An example mobile device is a smart watch 300 such as that shown schematically in FIG. 3.

At block 412, sensor(s) and computing system(s) of the mobile device and/or subject vehicle teach and/or learn about user movements—e.g., gestures—and associated desired vehicle functions. The learning can include learning how the user typically moves when trying to make gestures and correlating those to actionable gestures, such as in the mentioned table relating gestures and corresponding functions. The algorithm can be similar to those used to recognize user speech patterns in voice recognition and voice-to-text translation software, or handwriting habits, styles, or patterns.

In various embodiments, the system can have default organization of gestures available to use, and/or the user can organize the gestures, such as by establishing in the system levels of interaction—e.g., a first level of convenience/comfort gestures—e.g., unlocking/locking the doors, and interior or exterior lighting options when approaching the vehicle; and a second level for emergency situations—e.g., to activate sounds and alerts, and/or alert authorities. Exact location can be provided through the system in such circumstances using GPS or other location determined by the vehicle, wearable device, or remote system—e.g., the OnStar® system.

Teachings can include suggesting gestures for the user to use to trigger corresponding vehicle functions. The suggestions can be communicated to the user from the vehicle by a user device or by a vehicle-human interface (VHI), such as a vehicle speaker and/or visual display, for instance. the suggestions can include standard, or default, gestures already associated with corresponding vehicle functions.

At block 413, the computing system 100 of the mobile device and/or vehicle adopt or define default or personalized gesture controls based on user input, default programming, instructions or updates from a remote source—e.g., the OnStar® system—et cetera.

At block 414, the computing system and sensors of the mobile device and/or vehicle determines user disposition. The operation can include, for instance, determining that the user is approaching the vehicle, proximate the vehicle—e.g., within 20 feet, 10 feet, 5 feet, or other default or user-set distance—in the vehicle, or exiting the vehicle. In various embodiments, the system is configured to allow the user to change such default settings. The new relationship can be stored in the user profile referenced above in connection with the vehicle-function identification module 204.

At block 415, the computing system and sensors of the mobile device and/or vehicle detects and identifies a user gesture or movement. The computing system(s) then determine a vehicle function corresponding to the user movement. In embodiments in which it is the mobile device—e.g., smart watch 300—that determines the appropriate vehicle function(s), the mobile device transmits to the vehicle a signal or message indicating the appropriate vehicle function(s) determined at the mobile device.

At block 421, the computing system of the vehicle 102 implements local convenient or comfort functions determined, at the vehicle or mobile device 300, in the prior operation 415. Example functions in this section 420 include but are not limited to illuminating or blinking vehicle exterior lights (head lamps, tail lamps, turn signals, under vehicle-body lights and/or interior lights, door lock/unlock, or door, decklid, or trunk opening/closing.

At block 431, the computing system of the vehicle 102 implements local alert or emergency functions determined, at the vehicle or mobile device 300, in the prior operation 415. Example local functions here include actuating the vehicle horn, flashing exterior or interior lights, etc. In contemplated embodiments, the function includes the vehicle recording audio and/or video, such as to record a potential criminal situation involving or near the user.

At block 441, the computing system of the vehicle 102 and/or the mobile device 300 implements extra-vehicle-related functions determined, at the vehicle or mobile device 300, in the prior operation 415. Example functions here include initiating a phone call, a text message, transmitting of GPs location or video, such as that recorded at block 431. The phone call can be to 911, can be an automated call in which the vehicle provides a message to the receiver, or can be a user call in which live audio is transmitted. In a contemplated embodiment, the function includes any user mobile device or nearby recording device, such as parking-lot infrastructure, recording audio and/or video, such as to record a potential criminal situation involving or near the user.

The method 400 can end or any one or more operations of the method 400 can be performed again.

### V. Example System Inputs and Outputs—FIG. 5

FIG. 5 shows an arrangement 500 of example system inputs 510 and outputs 550 separated by a gesture recognition system 560, according to embodiments of the present technology.

The inputs 510 can be divided into three primary types: user gestures 520, off-board inputs 530 (off-board of the vehicle), and on-board inputs 540 (aboard the vehicle).

Example user gestures 520 including any of those reference above, such as user body part rotation 521, pointing or moving linearly 522, swiping 523, and clicking 524.

Example off-board inputs 530 including inputs from one or more vehicle cameras 541, other vehicle sensor(s) 542, a Bluetooth input to the vehicle 543, a remote input to the vehicle 544, such as from OnStar®, input from a vehicle or mobile device application 545, such as navigation or wearable location determining app, vehicle or vehicle-related controls or function inputs 546, such as a user touch pad, vehicle lighting, keyfob, locking/unlocking button or actuation, keyfob, and vehicle location input 547.

Example on-board inputs 540 include location information (e.g., GPS) or other data input from satellite 531, cellular 532, V2X 533 (V2V, V2I, etc.), or data via the internet 534, connected to in any suitable manner.

The gesture recognition system 560 in various embodiments includes any of the components provided above in connection with gesture recognition functions, such as user mobile device or vehicle sensors and computing systems.

The output functions 550 include but not limited to any of those described above, such as illumination of vehicle lights 551, locking/unlocking of vehicle door locks 552, actuating the vehicle horn 553, initiating a communication 554, such as a call or text message, or transmission 555 of mobile device or vehicle location and/or audio or video recorded at the mobile device, vehicle, or nearby structure, such as a parking lot camera.

### VI. Additional Features

Many of the features and embodiments of the present technology are described above. The present section restates some of those and references some others.

The technology in various embodiments includes an app that enables vehicle and wearable device communication to leverage gesture control capability inside, outside and around the vehicle, or during a transition, such as when a parent is securing a child into a car seat or reaching in the trunk. The app can be provisioned at the wearable device and/or at the vehicle.

The app can be programmed to learn user gesture style—e.g., gestures that are natural or more natural to the user.

The app and wearable device combine to enhance the user experience, including added convenience, comfort, property security, and personal security.

The app can be configured to learn user-gestures and generate personalized control options.

In various embodiments, the wearable device can be functional with—e.g., paired or pairable to—multiple vehicles. In this way, a user can use the technology using their mobile device with each of multiple vehicles in their household, for instance. Or a user can use the technology using their user mobile device and a rental vehicle, for instance.

The systems are configured in various embodiments to allow users to use gestures to control vehicle features from inside or outside of the vehicle to enhance personal security.

The systems allows the user to, by gesture, initiate communication of messages, cellular connections or communications, and transmission of video and/or GPS location data.

The technology in various embodiments can leverage various technologies found in existing wearable products and existing vehicles.

The wearable devices can be ornamental or fashionable, such as the devices looking like they are not clearly human-machine-interface (HMI) products.

### VII. Select Advantages

Many of the benefits and advantages of the present technology are described above. The present section restates some of those and references some others. The benefits described are not exhaustive of the benefits of the present technology.

The systems and methods of the present disclosure allow safer and more convenient use of a system such as an automobile.

The convenience and safety result from the user being able to trigger desired functions, when outside or inside the vehicle, in a hands-free manner. the triggering is accomplished by user gestures being detected by a wearable device and/or a sensor, such as an on-vehicle or on-user sensor. The user need not fiddle with a key fob, touch screen, key pad, and in some implementations, need not even use a wearable device.

Benefits in various embodiments include increased personal security when entering, exiting, and inside the vehicle.

For embodiments including wearable devices, additional cost, mass, packaging, and integration typically needed to incorporate sensors for related purposes (e.g., user identification or user gesture detection/determination) directly into the vehicle is avoided.

As mentioned, the wearable devices can be ornamental or fashionable, such as the devices looking like they are not clearly human-machine-interface (HMI) products.

### VIII. Conclusion

Various embodiments of the present disclosure are disclosed herein.

The disclosed embodiments are merely examples that may be embodied in various and alternative forms, and combinations thereof.

The above-described embodiments are merely exemplary illustrations of implementations set forth for a clear understanding of the principles of the disclosure.

Variations, modifications, and combinations may be made to the above-described embodiments without departing from the scope of the claims. All such variations, modifications, and combinations are included herein by the scope of this disclosure and the following claims.

What is claimed is:

1. A system, for use in implementing a vehicle function based on user gesture, comprising:
a hardware-based processing unit; and
a hardware-based storage device comprising:
a user-gesture determination module that, when executed by the hardware-based processing unit, determines a user gesture, made by a user proximate a vehicle, wherein the user gesture is not an under-vehicle user kick;
a vehicle-function identification module that, when executed by the hardware-based processing unit, determines a vehicle function pre-associated with the user gesture determined; and
a vehicle-function activation module that, when executed by the hardware-based processing unit, initiates performance of the vehicle function identified.

2. The system of claim 1 further comprising a vehicle performance component, wherein the vehicle-function activation module, when executed by the hardware-based processing unit, initiates performance of the vehicle function identified to be performed by the vehicle performance component.

3. The system of claim 2 wherein the vehicle performance component includes at least one component selected from a group of structures including a vehicle lock/unlock component, a vehicle lighting component, a vehicle transmitter or transceiver, and a vehicle camera or other vehicle sensor.

4. The system of claim 1 further comprising at least one sensor configured to sense or measure motion of the user, wherein the user-gesture determination module, when executed by the hardware-based processing unit, to determine the user gesture, receives user-motion input data from the at least one sensor.

5. The system of claim 1 wherein the user-gesture determination module, when executed to determine the gesture made by the user proximate the vehicle, receives, from a mobile device, a communication indicating the user gesture.

6. The system of claim 5 wherein the user mobile device is a user-wearable device being a bracelet, watch, cufflink, belt attachment, footwear attachment, a pair of eyeglasses, sunglasses, shirt, or ring.

7. The system of claim 1 wherein the system is a part of the vehicle.

8. The system of claim 1 wherein the system is a part of a user-wearable device.

9. The system of claim 1 wherein the vehicle function comprises at least one task selected from a group of tasks consisting of unlocking a vehicle door, locking the vehicle door, initiating an emergency call, transmitting a text, multi-media, or e-mail message, turning on, off, or blinking vehicle lights, actuating a vehicle horn, determining a vehicle location, transmitting location date indicating vehicle location and/or user location, initiating taking a video by a vehicle camera, user-possession camera, or other local camera, the video including an environment of the user and/or the vehicle, and transmitting video data including the video.

10. The system of claim 1 wherein:
the hardware-based storage device comprises a user-profile comprising data generated with user input and indicating a relationship between the user gesture and a corresponding vehicle function; and
the vehicle-function identification module, when executed by the hardware-based processing unit, determines the vehicle function using the user-profile.

11. The system of claim 1 wherein:
the hardware-based storage device comprises a proximity module that, when executed by the hardware-based processing unit, determines that the user is in or proximate the vehicle; and
the user-gesture determination module, when executed by the hardware-based processing unit, determines the user gesture only following determination that the user is in or proximate the vehicle.

12. A non-transitory and hardware-based computer-readable storage device, for use in implementing a vehicle function based on user gesture, comprising:
a user-gesture determination module that, when executed by a hardware-based processing unit, determines a user gesture, made by a user proximate a vehicle, wherein the user gesture is not an under-vehicle user kick;
a vehicle-function identification module that, when executed by the hardware-based processing unit, determines a vehicle function pre-associated with the user gesture determined; and
a vehicle-function activation module that, when executed by the hardware-based processing unit, initiates performance of the vehicle function identified.

13. The non-transitory and hardware-based computer-readable storage device of claim 12 wherein the vehicle-function activation module, when executed by the hardware-based processing unit, initiates performance of the vehicle function to be performed by a vehicle performance component.

14. The non-transitory and hardware-based computer-readable storage device of claim 12 wherein the user-gesture determination module, when executed by the hardware-based processing unit, to determine the user gesture, receives user-motion input data from at least one vehicle sensor.

15. The non-transitory and hardware-based computer-readable storage device of claim 12 wherein the user-gesture determination module, when executed by the hardware-based processing unit, to determine the user gesture, receives user-motion input data from a user mobile device at which the user gesture was sensed.

16. The non-transitory and hardware-based computer-readable storage device of claim 12 wherein:
the hardware-based storage device comprises a user-profile comprising data generated with user input and indicating a relationship between the user gesture and a corresponding vehicle function; and
the vehicle-function identification module, when executed by the hardware-based processing unit, determines the vehicle function using the user-profile.

17. The non-transitory and hardware-based computer-readable storage device of claim 12 wherein the hardware-based storage device comprises at least one of:
a teaching module that, when executed by the processing unit, provides a user-suggestion message indicating a corresponding particular vehicle function and a particular manner by which the user can gesture to trigger the corresponding particular vehicle function; and
a learning module that, when executed by the processing unit, perform a learning function including learning user gesture tendencies.

18. A method, performed, for implementing a vehicle function based on user gesture, by a system comprising a hardware-based processing unit and a module-containing hardware-based computer-readable storage device, the method comprising:
determining, by a hardware-based processing unit executing a user-gesture determination module stored at a hardware-based computer-readable storage device, a user gesture, made by a user proximate a vehicle, wherein the user gesture is not an under-vehicle user kick;
determining, by the hardware-based processing unit executing a vehicle-function identification module stored at the hardware-based computer-readable storage device, a vehicle function pre-associated with the user gesture determined; and
initiating, by the hardware-based processing unit executing a vehicle-function activation module stored at the hardware-based computer-readable storage device, performance of the vehicle function identified.

19. The method of claim 18 comprising performing the vehicle function using a vehicle performance component.

20. The method of claim 18 wherein determining the user gesture is performed by a sensor of a user mobile device.
